(19) United States
(12) Patent Application Publication
(10) Pub. No.: US 2011/0061688 A1
(43) Pub. Date: Mar. 17, 2011

(54) DEVICE AND METHOD FOR CLEANING WAFERS

(75) Inventors: Hans SCHNYDER, Nurnberg (DE); Manfred GÖTZ, Neumarkt (DE)

(73) Assignee: GEBRÜDER DECKER GMBH & CO. KG, Berching (DE)

(21) Appl. No.: 12/883,924

(22) Filed: Sep. 16, 2010

(30) Foreign Application Priority Data
Sep. 17, 2009 (DE) 102009041664.7-43
May 31, 2010 (DE) 102010022289.5-43

(51) Int. Cl. B08B 3/00

(52) U.S. Cl. 134/34; 134/166 R

(57) ABSTRACT

The invention relates to a device for cleaning wafers according to the wire-saw process and comprising
a holding plate (2, 20) which is connected on its first principal surface to an ingot (1),
a mounting plate (3) which is connected to the second principal surface of the holding plate (2, 20),
a device for feeding flushing fluid to clean the wafers in the area of the sawing gaps, where
the holding plate (2, 20) comprises a plurality of flushing channels (4) or flushing ducts (17) distributed over the surface and oriented towards the ingot (1),
one end of preferably each flushing channel (4), specifically that end facing away from the ingot (1), lies opposite the reservoir (5) for flushing fluid.

### SUBJECT

The present invention relates to a device and a process for cleaning wafers and according to the wire-saw process according to the preamble of claim 1 or claim 17.

### TECHNOLOGICAL BACKGROUND

Wafers, e.g. silicon wafers, are at present customarily produced from a block (ingot) in the so-called wire-saw process. The sawing is done with the aid of an encircling wire and a sawing fluid containing abrasive particles, said sawing fluid being located on the wire. Due to the abrasive particles of the sawing fluid the wire continuously “eats” into the ingot suspended on one side of a holding plate and in so doing separates the ingot into individual slices, the so-called wafers. However, after the wafers have been sawed in this manner they remain, as before, connected to a mounting plate by gluing. After completion of the sawing process the sawing fluid is located in the sawing gaps on the cut surfaces of the respective wafers, which on the one hand causes a cohesion of the wafers due to adhesion and on the other hand causes the cut surfaces of the individual wafers to be contaminated by the particles of the sawing fluid as well as by the sawing swarf (silicon sawing swarf). However, further processing of the wafers assumes cleaning of the same so that any remnants of particles of the sawing fluid have been removed.

### STATE OF THE ART

DE 102 20 468 A1 describes a process and a device for cleaning wafers in which process and device the flushing fluid is forcibly conducted via a distributor channel between the wafers into the individual sawing gaps. The holding plate to which the ingot is glued comprises for this purpose a single, preformed, central, longitudinally running distributor channel which is supplied with flushing fluid via a corresponding channel in the mounting plate. During the sawing process the holding plate is sawed on in the area of the gluing to the ingot. Due to the conducting of the flushing fluid via the central channel as well as the additional channels produced by the sawing of the holding plate, flushing fluid arrives in the area of the sawing gaps and leads to a flushing of sawing remnants, in particular sawing particles, out of the sawing gaps. However, this known process has the disadvantage that especially the outer areas of the respective sawing gaps are only cleaned inadequately. This the result is that over the total volume of wafers in a sequence only inhomogeneous cleaning action results Furthermore, this known process is not usable for silicon blocks of greater length since in the known process the cleaning action decreases with the length of the channel.

From US 2009/0117713 A1 a process for reducing the adhesive forces in the area of the sawing gaps of a wafer arrangement is described. In this process it is proposed to introduce into the area of the sawing gaps, by means of a liquid or gaseous medium, small particles which are supposed to serve as a spacer and thus to overcome the forces of adhesion. This leads to simpler washing and individual separation of the wafers. Spacers of plastic or glass have been proposed as suitable spacers. However, the spacer particles must be removed after the individual separation of the wafers.

### OBJECT

The object of the present invention consists in providing a generic device and process with which device or process for one thing better cleaning of wafer arrangements is made possible.

Furthermore the generic device is intended to have a simpler design.

### DESCRIPTION OF THE INVENTION

The present object is realized by the features of claim 1. The subordinate claims relate to expedient developments of the invention.

According to the invention there is provided a 3-dimensional as well as 2-dimensional flushing fluid reservoir oriented toward the ingot. This reservoir makes it possible to supply flushing fluid, as needed and in the immediate vicinity of the ingot, over a large area, i.e. essentially adapted to the dimensions of the ingot, as well as into the sawing gaps. The demarcation of the reservoir is done by the thin-walled holding plate fixedly connected to the ingot. Through sawing cuts in the holding plate, which preferably are introduced into it simultaneously with the sawing of the ingot, a flushing connection between the transversely oriented reservoir and the individual sawing gaps of the ingot can be produced.

Preferably a plurality of flushing ducts are provided as a flushing connection, where each flushing duct connects the reservoir with a flat surface to the corresponding sawing gap directly and vertically. Due to this there is, over the entire width, an immediate as well as non-deflected entry of the flushing fluid from the reservoir into the ingot's sawing gap associated with that flushing duct.

The flushing duct as well as the sawing gap in the ingot preferably have an equal sawing width as well as cut orientation since they are produced by one and the same cutting process.

The reservoir's conception according to the invention makes it possible that said reservoir has a surface which is adapted to the dimensions of the ingot, at least of half of it, and preferably corresponds to at least two-thirds of the cross-sectional surface of the ingot. Also, the reservoir can be formed so as to correspond to the cross-sectional form of the ingot (square, rectangular, etc.). In this way an optimal cleaning action over the entire surface of the ingot is produced.

For simplified introduction of the flushing ducts through the sawing cut, the holding plate comprises an indentation or reduced wall thickness in that area in which the flushing ducts are introduced.

Due to the fact that at least one projection, preferably a plurality of projections, in particular in the form of a rib or stud, extends, or extend, out from the plate in the upwards direction into the reservoir, the sawing wire continues to be guided even when it has sawed upwards through the base of the holding plate to produce the flow connection. In this way the sawing wire can once again be introduced in its exact position into the sawing gap in the base of the holding plate, that is, be guided out of the sawing gap in the downwards direction without hanging on the base of the holding plate. Thus the sawing wire does indeed exit from the plane of the base of the holding plate in the area of the projection, but the sawing wire remains in the area of the projection which is in alignment with the corresponding sawing gap and therefore said sawing wire also remains in corresponding alignment. The projection is not sawed through completely in the upwards direction.

Expediently the projection is oriented transverse to the sawing plane.

According to a further expedient development of the present invention the holding plate comprises a plurality of preferably elongated flushing channels oriented towards the ingot and distributed over the surface in the transverse and/or longitudinal directions. Furthermore, an end of the respective flushing channel, specifically that end facing away from the ingot, lies opposite to a reservoir for flushing fluid or is immediately adjacent to it. Due to the plurality of the flushing channels preformed in the holding plate, a homogeneous entry of flushing fluid into the respective sawing gap is ensured and thus an optimal flushing action is achieved. At the same time a flushing fluid reservoir in the holding plate's area lying opposite the individual flushing channel provides for a uniform pressure distribution at the connecting surface to the ingot so that even ingots with larger dimensions, in particular greater lengths, can be cleaned in an optimal manner. The invention thus makes it possible to significantly improve both the cleaning intensity and the cleaning speed in comparison to customary devices. The device according to the invention has the additional advantage that it not only makes possible a preliminary cleaning but rather also a final cleaning. Moreover, due to the distributed flushing channels and, resulting therefrom, the adhesive surface distribution which is present after the wire-sawing process, a particularly favorable “degluing,” i.e. separation of the adhesive layer between the ingot or wafer and the holding plate is possible.

In an advantageous manner the reservoir for flushing fluid lies opposite at least a part of the flushing channels, preferably all the flushing channels, along the holding plate as a common reservoir. This supports the possibility of a homogeneous introduction of flushing fluid into the individual sawing gaps.

Due to the fact that according to an expedient development of the present invention the reservoir is formed by a cavity bounded by the holding plate and the mounting plate, the reservoir can be provided by corresponding shaping of the holding plate and the mounting plate in a manner that is simple from the point of view of construction and thus more economical.

Especially in the case of ingots of great length, and as a consequence of these correspondingly dimensioned holding plates, it is advantageous to divide the reservoir into individual zones using individual partitioning walls, whereby the pressure relationships over the length of the holding plate can be considered homogenized and thus optimized. In addition it can be provided expediently to equip each zone with a suitable flushing fluid inlet which is expediently positioned at the lateral area of the reservoir, for example, on the mounting plate or holding plate.

Alternatively, the respective flushing agent inlet can also be located on the upper side of the device, thus, for example, on the upper side of the mounting plate, which aids in handling within a confined space.

In order to make a quick exchange possible, the respective flushing agent inlet can be provided with its own quick-action coupling for connecting or disconnecting a flushing fluid line.

According to a development of the present invention the flushing channel is shaped as a blind hole so that between the blind hole's end oriented towards the ingot and the lower surface of the holding plate a layer of material remains. The opening of the flushing channel up to the sawing gap is accomplished by the lower side of the mounting plate being sawed on.

Furthermore, the respective flushing channel can be disposed at the base of an indentation located in the holding plate, in which indentation, during flushing, there is also flushing fluid from the reservoir for, in particular, a plurality of flushing channels. In particular a type of channel effect for the flow to the flushing channels can be achieved thereby. Moreover, this development ensures, given sufficient rigidity, a forming suitable for the production of the holding plate.

The indentation can in this case be provided preferably in a linear form and in such a manner that, for example, several linear indentations are disposed parallel to one another in the longitudinal directional of the holding plate and distributed over its width.

The form of the flushing channels can be different depending on the application requirements. For example, the flushing channels can have a round shape or also an elongated, e.g. slot-like, shape.

Adjacent flushing channels can be disposed offset relative to one another. Due to the proposed construction the invention permits the realization of the most varied shapes of flushing channels.

The holding plate, i.e. the plate which is glued to the ingot, is expediently provided as a plastic part, preferably as a synthetic resin part or a cast resin part. Alternatively however, a holding plate of ceramics or glass or glass ceramics can be used, in particular when dealing with a holding plate of simple form.

The present invention furthermore relates to a process for cleaning wafers according to the wire-saw process which is characterized by solving the problem set in the introduction through the following process features:
a) introducing a flushing fluid into a reservoir which is located in the area of the holding plate,
b) discharging the flushing fluid from the reservoir in the direction essentially perpendicular to the holding plate and into the sawing gaps of the ingot via flushing channels or flushing ducts which lie opposite the reservoir, are distributed over the surface of the holding plate in the transverse and/or longitudinal direction, and are preferably directed towards the ingot.

The discharging of the flushing fluid from the reservoir into the sawing gaps of the ingot is done under pressure or under the gravitational force of the flushing fluid. The flow connection between the respective flushing channel or flushing duct and the sawing gap is provided by sawing on the holding plate or by sawing through the holding plate, in either case preferably while sawing the ingot.

### DESCRIPTION OF THE EMBODIMENT EXAMPLES

Expedient developments of the present invention will be explained in the following with the aid of drawings. Recurring features are provided with a reference number only once for the sake of comprehensibility. Shown are:

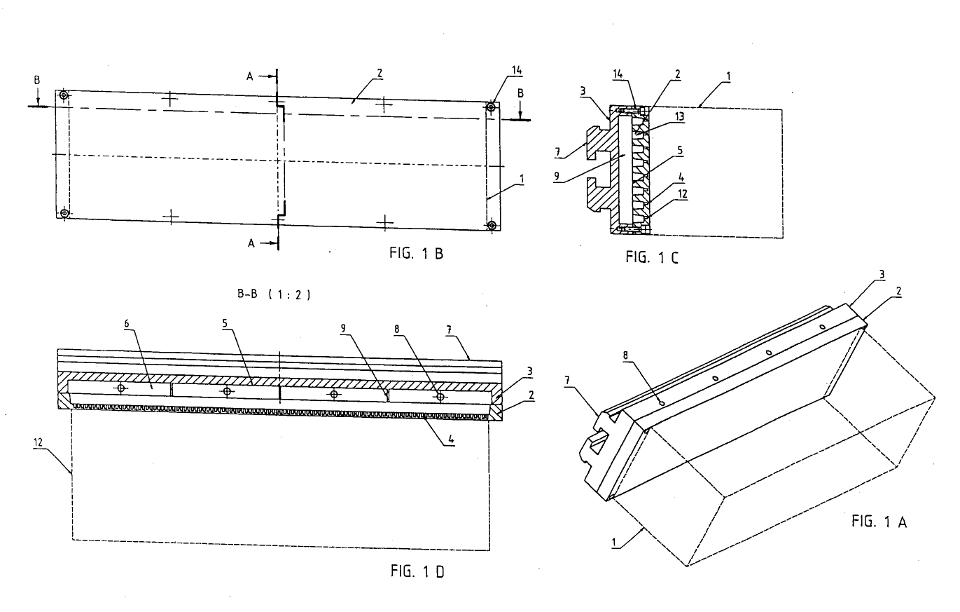

FIG. 1 a first development of the device according to the invention together with an ingot fastened thereto, in perspective view (FIG. 1A), a view of the underside of the holding plate (FIG. 1B), a sectional representation along the plane A-A in FIG. 1B (FIG. 1C), a sectional representation along the plane B-B in FIG. 1D);

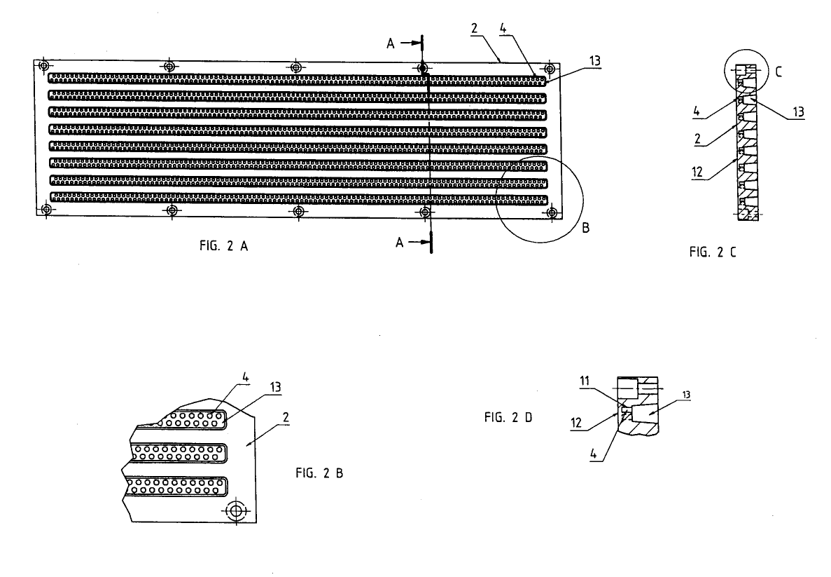

FIG. 2 a representation of the holding plate of the development according to

FIG. 1 in plan view (FIG. 2A), a detail view of the area B in FIG. 2A (FIG. 2B), a sectional representation along the sectional plane A-A in FIG. 2A (FIG. 2C) and a detail view of the area C of FIG. 2C (FIG. 2D),

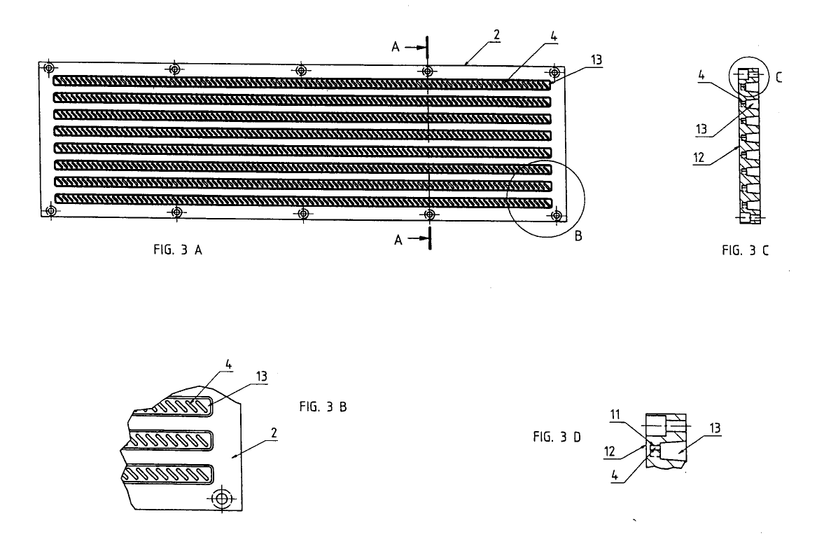

FIG. 3 a representation of the holding plate of the development according to (FIG. 3B), a sectional representation along the sectional plane A-A in FIG. 3A (FIG. 3C) and a detail view of the area C of FIG. 3C (FIG. 3D),

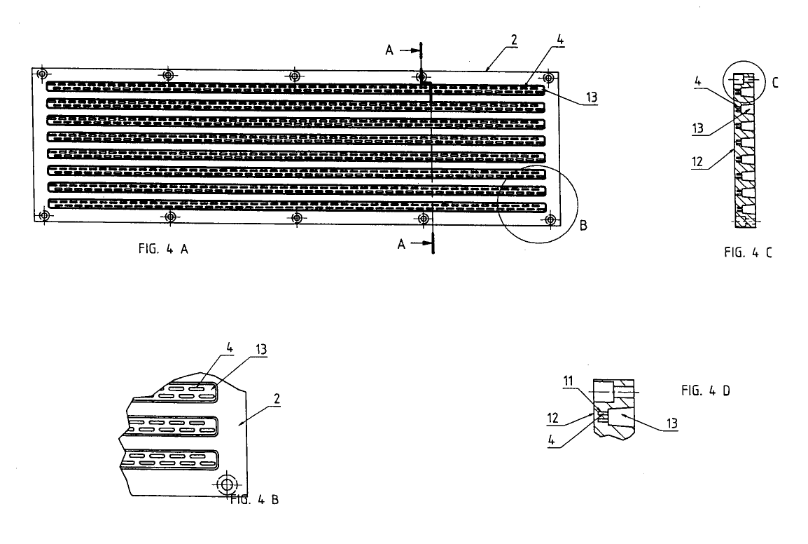

FIG. 4 a representation of the holding plate of the development according to FIG. 1 in plan view (FIG. 4A), a detail view of the area B in FIG. 4A (FIG. 4B), a sectional representation along the sectional plane A-A in FIG. 4A (FIG. 4C) and a detail view of the area C of FIG. 4C (FIG. 4D),

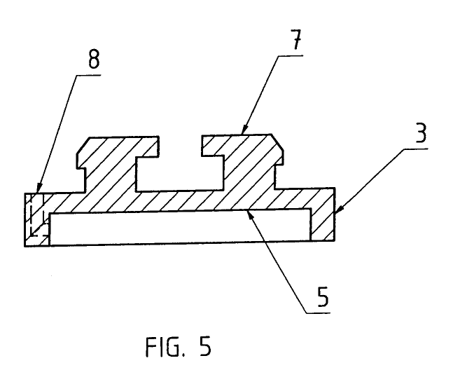

FIG. 5 a sectional representation through the mounting plate of a further development of the present invention with a flushing fluid inlet on the upper side,

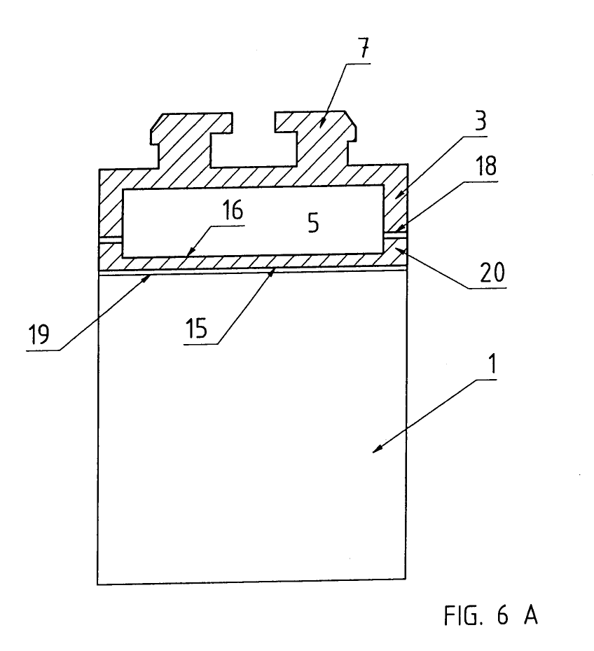

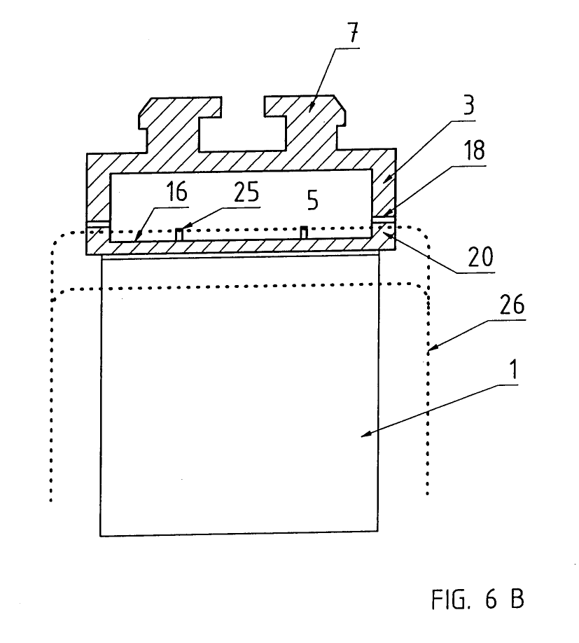

FIG. 6 a second development of the device according to the invention with an ingot fastened thereto in sectional representation before the production of the flushing ducts without projection (FIG. 6 A) and with projection (FIG. 6 B);

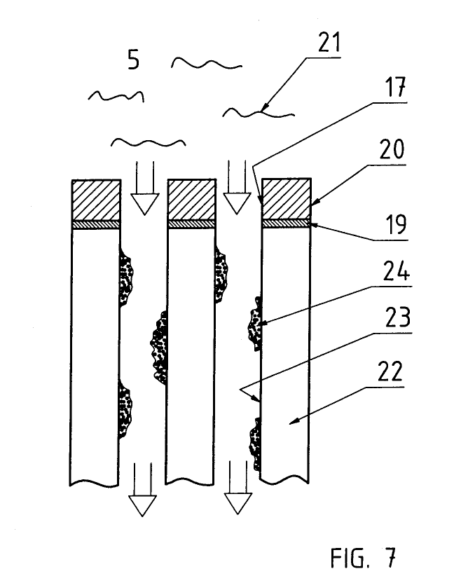

FIG. 7 a partial sectional representation of the devices according to FIG. 6 after introducing the flushing ducts during the flushing process in sectional representation and

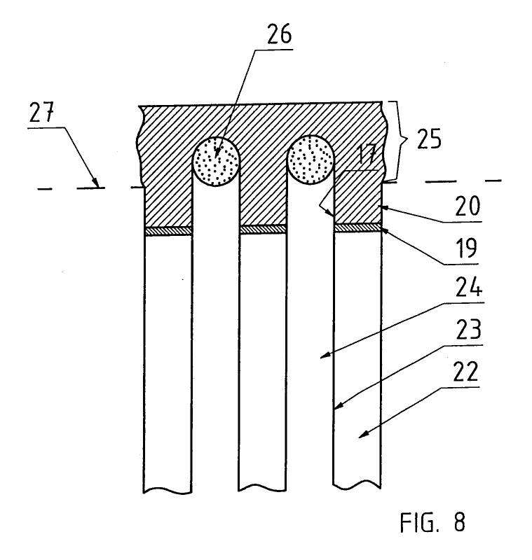

FIG. 8 a partial sectional representation of the devices according to FIG. 6 B during the sawing process.

FIG. 1A shows, in perspective representation, a first development of the device according to the invention, where the ingot, e.g. a silicon block, is merely indicated by dotted lines. The ingot 1 is glued over its entire surface to the underside of the holding plate 2 (also called the “sawing support”) by means of a suitable adhesive. On the upper side of the holding plate 2 there is a mounting plate 3 (also called the “machine carrier”) with mounting projections in the form of a mounting rail 7 for fastening of the entire arrangement in a wire saw (not represented). In this development several flushing fluid inlets 8, whose significance will be described later, are located in the area of the lateral face of the mounting plate 3.

The holding plate 2 expediently consists of porcelain, of a ceramic material, of glass, or of a resin, in particular of cast resin. It has a thickness of ca. 2-25 mm, preferably 5-15 mm.

FIG. 1B shows the holding plate 2 in a view from below. To be seen in each corner area are the screws 14 between the holding plate 2 and the mounting plate 3 (cf. also FIG. 1C).

The holding plate 2 and the mounting plate 3 together form a reservoir 5 for flushing fluid. This reservoir 5 extends over the entire width the holding plate 2 and over its entire length. Thus flushing fluid is present along the entire surface of the holding plate 2 with the exception of the walls of the mounting plate 3 and with the exception of partitioning walls 9 (described later).

Furthermore the holding plate 2, as represented in FIG. 1C, is equipped with a plurality of individual flushing channels 4 preferably directed towards the ingot 1. The flushing channels 4 serve to introduce under pressure the flushing fluid located in the reservoir 5 directly into the individual sawing gaps (not represented) of the ingot 1 and thus to achieve a homogeneous cleaning action in the longitudinal direction as well as in the transverse direction of the ingot 1.

As can be seen from FIG. 1D, the reservoir 5 can be subdivided into several zones 6 by means of individual partitioning walls 9. The three partitioning walls 9 in FIG. 1D consequently provide a total of four zones 6. The individual zones 6 can be equipped with an independent flushing fluid supply. From this the possibility also results of implementing a flushing process in the manner of a cascade (cascade flushing). For this purpose one flushing fluid inlet 8 for each zone 6 is provided in the area of the mounting plate 3. The result of this is an optimal pressurization of the flushing fluid over ingots 1 of greater length.

Each flushing fluid inlet 8 can have its own quick-action coupling (not represented) which allows the respective flushing fluid inlet 8 to be quickly coupled to or decoupled from a tubular connector.

The partitioning walls 9 are dimensioned so that as a rule they reach up to the holding plate 2.

As becomes clear from FIG. 1D, the reservoir 5 is formed by the mutual engagement of the holding plate 2 and the mounting plate 3. For this purpose the mounting plate 3 comprises a large-surface recess within which the individual partitioning walls 9 are located.

FIG. 2A shows the underside of the holding plate 2. The individual flushing channels 4 are disposed in groove-like indentations 13 and in each indentation in double rows and offset with respect to one another. The groove-like indentations 13 are distributed over the width of the holding plate 2 miming parallel to one another. The lateral walls of the groove-like indentation 13 are preferably formed so as to taper in the direction towards the ingot 1, which simplifies the entry of the flushing fluid from the reservoir 5 into the flushing channels 4.

As can be seen from FIG. 2C or FIG. 2D, the flushing channel 4 there is formed by a blind hole 11 on the base of the indentation 13 with the consequence that a material layer 12 remains on a surface of the holding plate 2, specifically that surface lying opposite the indentation 13. This surface is the mounting side for the ingot, the side on which the adhesive is located.

In the wire-saw process the holding plate 2 is sawed on in the area of the material layer 12 and thereby the flushing channel 4 is opened towards the ingot.

According to FIG. 2B the blind holes 11 have a circular periphery and are offset with respect to one another. The diameter of a corresponding flushing channel 4 lies in a range of 0.5 mm to 5.0 mm.

The development of the present invention according to FIGS. 3A-3D differs from the development described above in the shape of the flushing channels 4. These are blind holes of elongated, slot-like form and have an oblique orientation within their respective indentation 13.

The development of the present invention according to FIGS. 4A-4D differs once again in the shape of the flushing channels 4. In this development the flushing channels 4 are also of elongated, slot-like form but oriented in the longitudinal direction of the respective indentation 13 and offset with respect to the adjacent flushing channel 4.

The representation according to FIG. 5 shows a development of the present invention in which the flushing fluid inlets 8 are not located in the lateral area of the device but rather on the upper side of the same. In this way the mounting plate 3 has a channel accessible from its upper side, said channel emptying into the interior of the reservoir 5. In several zones several such flushing fluid inlets 8 are also provided corresponding to the above-described developments of the present invention.

Instead of screwing the holding plate 2 onto the mounting plate 3 they can also be glued to one another.

FIG. 6 shows a second development of the device according to the invention in which device the holding plate 20 comprises no preformed flushing channels of the type identified by the reference number 4 in the preceding forms of embodiment. Rather the holding plate 20 is disposed either as a simple plate or, as represented in FIG. 6, with an interior upper side 16 or with a reduced wall thickness. In this form of embodiment the base 15 of the holding plate 20 is connected to the mounting plate 3 via an adhesive layer 18. Alternatively however, any other possible form of connection, such as, for example, screwing or the like, can be provided. The ingot is once again also connected to the underside of the holding plate 20 via an adhesive layer 19. Up to the configuration of the holding plate 20 the design is identical to that of the first form of embodiment so that reference can be made thereto.

As can be seen from FIG. 6 A, the holding plate 20 and the mounting plate 3 form a reservoir 5 for flushing fluid, said reservoir extending nearly over the entire width and length of the ingot 1. In any event the construction makes it possible that the surface area of the reservoir 5 can cover an area of at least half of the horizontal cross-sectional surface of the ingot 1, preferably at least two-thirds of the cross-sectional surface up to the entire cross-sectional surface of the ingot 1.

In the development according to FIG. 6 B two projections 25 extend from the base of the holding plate 20 into the reservoir 5. The projections 25 have the shape of a rib or a stud and are oriented transversely to the sawing plane. Alternatively the projections 25 could also, for example, be disposed obliquely to the sawing plane. The reference number 26 denotes the sawing wire, which runs around continuously and of which merely a partial piece is reproduced. The lower dotted line running transversely in FIG. 6 B shows the sawing wire 26 just below the holding plate 20. During the sawing process the sawing wire 26 migrates within the ingot 1 more and more towards the holding plate 20, ultimately cuts through the base 15 of the holding plate 20, and then meets the upper side 16 of the base 15 of the reservoir (this corresponds to the plane 27 of the reservoir in FIG. 8). In so doing, the latter cuts a sawing gap into the stud 25, said stud according to FIG. 8 extending the sawing gap 23 present in the holding plate 20 in the upwards direction while simultaneously holding the sawing wire 26 in its exact alignment. When the sawing wire 26 is subsequently removed, the sawing wire 26 has to be drawn out once again through the sawing gap 23 but the sawing wire 26 remains in its exact alignment throughout this process.

The thickness of the base of the holding plate expediently lies in the range of ca. 2-6 mm.

FIG. 7 shows, for better understanding, an enlarged partial area of the transition from the reservoir 5 into the respective sawing gap 23. According to the invention the sawing process for producing a sawing gap 23 is done through the base 15 of the holding plate 20 so that, per sawing cut, one flushing duct 17 arises in the holding plate 20 and the adhesive layer 19, said flushing duct connecting the reservoir 5 to the sawing gap 23 directly and vertically. Consequently after a successful sawing process there is a plurality of individual, elongated flushing ducts 17 over the entire width of the ingot 1 and consequently due to the full-surface extension of the reservoir 5 over the entire width of the reservoir 5.

The geometry (width) and orientation of the flushing ducts 17 and sawing gaps 23 are identical since both are produced by a single corresponding sawing cut.

After successful sawing of the ingot 1, flushing fluid 21 is, as represented in FIG. 7, introduced into the reservoir 5 and is conducted under pressure or under the force of gravity through the individual flushing ducts 17 as well as the sawing gaps 23 in the ingot 1 (see the arrow in FIG. 7), so that particles of dirt or sawing particles 24 in the sawing gaps 23 can be removed effectively over the entire width of the ingot 1.

Due to the disposition of the reservoir 5 between the holding plate 2 and the mounting plate 3 it is possible to conceive the holding plate 2 as a molded plastic part, in particular a cast resin part. With a cast resin part the molding of the indentations as well as the individually disposed flushing channels 4 can be realized with sufficient strength. With regard to the simple form of the holding plate 20 according to FIGS. 6 and 7 there is the advantage of also using a holding plate consisting of glass, ceramics, or glass ceramics.

Alternatively, the holding plate can also consist of another material.

The process according to the invention is characterized by the following process features.
a) introducing a flushing fluid into a reservoir which is located in the area of the holding plate,
b) discharging the flushing fluid in the direction essentially perpendicular to the holding plate and into the sawing gaps of the ingot via flushing channels or flushing ducts which lie opposite the reservoir, are distributed over the surface of the holding plate in the transverse and/or longitudinal direction, and are preferably directed.

It is particularly advantageous that from a large reservoir volume of flushing fluid said fluid can be discharged directly through the flushing channels 4 in a flat distribution into the individual sawing gaps of said ingot and thereby the cleaning effectiveness as well as the cleaning speed can be increased significantly.

The flow connection between the respective flushing channel 4 and the wafer gap is caused by sawing on the holding plate 2 or sawing through the base 15 of the holding plate 20.

All in all the present invention represents a quite special contribution in the relevant field of the art and makes it possible to simultaneously and significantly increase the production speed in the field of the preliminary and final cleaning of said silicon ingots.

### LIST OF REFERENCE NUMBERS

1 Ingot
2 Holding plate
3 Mounting plate
4 Flushing channel
5 Reservoir
6 Zone
7 Mounting rail
8 Flushing fluid inlet
9 Partitioning wall
10 Quick-action coupling
11 Blind hole
12 Material layer
13 Indentation
14 Screws
15 Base
16 Upper side of the base of the holding plate
17 Flushing duct
18 Adhesive layer
19 Adhesive layer
20 Holding plate
21 Flushing fluid
22 Wafer
23 Sawing gap
24 Sawing particle
25 Stud
26 Sawing wire
27 Plane base, reservoir

1. Device for cleaning wafers (22) according to the wire-saw process and comprising
a holding plate (2, 20) which is connected on its first principal surface to an ingot (1),
a mounting plate (3) which is connected to the second principal surface of the holding plate (2, 20),
a device for conducting flushing fluid (21) to clean the wafers (22) in the area of the sawing plate (23),
wherein
a flat-surface reservoir (5) for flushing fluid (21) is provided,
the holding plate (2, 20) bounds the reservoir (5) in the direction of the ingot (1), and
sawing cuts in the holding plate (2,20) establish a flushing connection between the reservoir (5) and the individual sawing gaps (23) of the ingot (1).

2. Device according to claim 1,
wherein
a plurality of flushing ducts (17) are provided as a flushing connection and each flushing duct (17) directly connects the reservoir (5) to the corresponding sawing gap (23).

3. Device according to claim 1 or 2,
wherein
the flushing duct (17) and the respective sawing gap (23) in the ingot (1) have identical cut widths and cut orientations.

4. Device according to claim 1,
wherein
the reservoir (5) has a surface which corresponds to an area of at least half, preferably at least two-thirds of the cross-sectional surface up to the entire cross-sectional surface of the ingot (1).

5. Device according to claim 1,
wherein
the holding plate (20) comprises an indentation which determines the lower area of the reservoir (5).

6. Device according to claim 1,
wherein
at least one projection (25) extends from the holding plate (20) into the reservoir.

7. Device according to claim 1,
wherein
the holding plate (2) comprises a plurality of flushing channels (4) distributed over its surface and oriented towards the ingot (1) and
one end of a flushing channel (4), specifically that end facing away from the ingot (1), lies opposite the reservoir (5) for flushing fluid.

8. Device according to claim 7,
wherein
the reservoir (5) lies opposite at least a part of the flushing channels (4), preferably all the flushing channels (4).

9. Device according to claim 1,
wherein
the reservoir (5) is formed by a cavity bounded by the holding plate (2, 20) and the mounting plate (3).

10. Device according to claim 1,
wherein
there is provided at least one partitioning wall (9) which passes through the reservoir (5) and divides the reservoir (5) into individual zones (6).

11. Device according to claim 10,
wherein
each zone (6) has a corresponding flushing fluid inlet (8).

12. Device according to claim 11,
wherein
the respective flushing fluid inlet (8) is located either in the area of the upper side of the device or in the area of the long side of the device.

13. Device according to claim 11,
wherein
the flushing fluid inlet (8) is provided with a quick-action coupling (10) for connecting or disconnecting a flushing fluid line.

14. Device according to claim 7,
wherein
the flushing channel (4) is formed as a blind hole (11).

15. Device according to claim 14,
wherein
the respective flushing channel (4) is disposed on the base of an indentation located in the holding plate (2).

16. Device according to claim 15,
wherein
the indentation (13) is linear and several indentations (13) are disposed parallel to one another in the longitudinal directional of the holding plate (2) and are distributed over its width.

17. Device according to claim 1,
wherein
the holding plate (2, 20) is a plastic part, in particular a part made of resin, or the holding plate (2, 20) consists of glass, ceramics, or glass ceramics.

18. Process for cleaning wafers according to the wire-saw process, wherein flushing fluid is conveyed via the holding plate to the respective sawing gap of the ingot,
wherein
the following process steps:
a) introducing a flushing fluid (21) into a reservoir (5) which is located in the area of the holding plate (2, 20),
b) discharging the flushing fluid (21) in the direction essentially perpendicular to the holding plate (2, 20) into the sawing gaps (23) of the ingot (1) via elongated flushing channels (4) or flushing ducts (17) which lie opposite the reservoir (5), are distributed over the surface of the holding plate (2, 20) in the transverse and/or longitudinal direction, and are preferably directed towards the ingot (1).

19. Process according to claim 18,
wherein
the flow connection between the flushing channel (4) and the sawing gap (23) is established by sawing on the holding plate (2).

20. Process according to claim 18,
wherein
the flushing ducts (17) are produced by sawing through the base (15) of the holding plate (20) during the sawing of the ingot (1).
